(19) United States
(12) Patent Application Publication
(10) Pub. No.: US 2013/0238830 A1
(43) Pub. Date: Sep. 12, 2013

(54) BUS EXTENSION FRAMEWORK SYSTEM

(71) Applicants: Michael Andrew Pouchak, Saint Anthony, MN (US); Ralph Collins Brindle, Edina, MN (US)

(72) Inventors: Michael Andrew Pouchak, Saint Anthony, MN (US); Ralph Collins Brindle, Edina, MN (US)

(73) Assignee: HONEYWELL INTERNATIONAL INC., Morristown, NJ (US)

(21) Appl. No.: 13/415,765

(22) Filed: Mar. 8, 2012

(51) Int. Cl. G06F 13/00

(52) U.S. Cl. 710/305

(57) ABSTRACT

A control system having a bus extension framework. The system may have a flexible and reuseable block mechanism which may integrate with block control structures, and yet provide connections over a low cost two-wire communications bus. A function block engine may extend to multiple devices such as sensors, actuators, In/output devices, wall modules, graphical displays, network storage mechanisms, and so on. The system may integrate with other graphical function block systems and extend with a simple connection to and from additional bus resources. A connection scheme may hide the complexity of the underlying communications and still permit multiple address devices to communicate to each other among function block host devices. Complexity of the underlying communications may be revealed graphically to a system operator in an under-the-hood view. A main host controller may have a proxy file that holds a data file on virtually all of the devices in the system.

### BACKGROUND

The present disclosure pertains to control systems and particularly to systems having block, modular and/or node structures. More particularly, the disclosure pertains to structures centering on communication buses.

### SUMMARY

The disclosure reveals a control system having a bus extension framework. The system may have a flexible and reuseable block mechanism which may integrate with block control structures, and yet provide connections over a low cost two-wire communications bus. A function block engine may extend to multiple devices such as sensors, actuators, In/output devices, wall modules, graphical displays, network storage mechanisms, and so on. The system may integrate with other graphical function block systems and extend with a simple connection to and from additional bus resources. The present connection scheme may hide the complexity of the underlying communications and still permit multiple address devices to communicate to each other among function block host devices. The complexity of the underlying communications may be revealed graphically to a system operator which may be regarded as an under-the-hood view. A main host controller may have a proxy file that holds a data file on virtually all of the devices in the system. Graphical connections between the bus devices and function control block devices may be set in a simple block manner. The present system may extend to the function block engine with extensive In/output and processing power. The system may be based on a modular or block approach to represent communications and connections. Source and destination blocks may be intermixed seamlessly to represent the sensors, actuators, displays, control block features, and so on. The present system may also be structured to communicate with node systems.

### BRIEF DESCRIPTION OF THE DRAWING

FIG. 1 is a diagram which shows a modular graphical bus extension framework system;

FIG. 2 is a diagram of a simplified connection in a block form that abstracts the connection and configuration information;

FIG. 3 is a diagram of a modular graphical graph extension block system;

FIG. 4 is a diagram of a controller which may be referred to in the present disclosure;

FIG. 5 is a diagram of a wall module which may be referred to in the present disclosure;

FIG. 6 is a diagram of a screen print showing sample linked parameters for a wall module configuration wizard;

FIG. 7 is a diagram of a temperature and humidity sensor;

FIG. 8 is a diagram of an actuator;

FIG. 9 is a diagram of a restaurant setup as an example of a system with integration; and

FIG. 10 is a diagram of a schematic of a restaurant system some components and their connections;

FIG. 11 is a diagram of blocks representing components of the restaurant system along with the connections;

FIG. 12 is a diagram like that of FIG. 11 with identification some of the example connections among the components;

FIG. 13 is a diagram concerning a function block of the restaurant system with an example of an under-the-hood indication of details of the block; and

FIGS. 13-26 are diagrams of more indications of details of other components represented by block-like symbols in FIG. 11.

### DESCRIPTION

In the commercial buildings heating, ventilation and air conditioning (HVAC) control industry, programmable direct digital control (DDC) may be enabled by advancements in powerful microprocessor and computer controls. As the power of programmable control languages and advancement of communications increase (including Lon and Bacnet), additional structures appear to become advantageous to develop efficient and price-sensitive embedded HVAC control systems including efficient control block structures and graphical control design tools.

With the advantages of reusable control block structures and HVAC applications, a low cost digital communication bus may be connected in at a lower price point than that of controller bus communications (Lon and Bacnet). The modular interface and representation and connection of information to the base HVAC application controller platform may provide an opportunity to use a flexible and reusable block mechanism that can integrate with digital block control structs, yet represent communication over a low cost data/power digital communication bus to communicate and control with other digital displays, sensors and actuators. A modular and flexible framework may be provided to integrate and control low cost digital bus devices in an overall control system. An extension of low cost communication may be represented in a graphical block environment that integrates with the HVAC control block graphical design. An approach may need to address the underlying mechanisms and structures that allow the information and representation to be encapsulated in a form that is usable and incorporates the digital bus mechanisms graphically while providing a way for communications between low cost digital bus devices and host devices to be preserved. The present approach may allow a function block engine to extend to multiple digital bus devices such as sensors, actuators, digital relays and other input/output (IO) devices, remote wall modules, graphical displays and remote computer resources such as external energy measuring equipment, smart grid devices, external computing resources such as high performance customizable function block extensions, network storage devices, and automated test and database storage and retrieval devices. With an ability to connect to multiple devices addresses on the low cost digital system bus (presently at a lower bandwidth but could easily be extended to a much higher bandwidth), there may be powerful applications that allow interconnections in a very efficient and graphically intuitive format.

The present approach may incorporate interoperating graphical blocks that allow seamless integration between controller block devices and low cost digital bus devices that use an underlying low cost digital communication configuration and communication system. The individual communication paths may be represented by connection lines that are not part of the underlying control block control system, but represent a separate sub-system that is distributed on the low cost digital communications bus. As individual devices are added and connected to the main control block system environment, underlying translations may be made between the main control block system and the low cost digital communication bus environment. Challenges that have been implemented in the present framework may include allocation of device address resources, an ability to manage and connect multiple address block I/O and storage variable types along with allowing connection rates and failure mechanisms. The present approach appears to be powerful and unique in that it may cleanly integrate with previous graphical function block systems, and extend the simple connection to allow communication to and from additional digital bus resources. The connection scheme may hide the complexity of the underlying low cost digital communications bus and allow the important information to be extended to permit multiple address devices to talk to each other or to function block host devices. The main controller host proxy file may hold the entire individual low cost digital communication device data file and be distributed to the individual controller nodes on needed communication events. By allowing the group/send communication information to be specified in the host controller and individual nodes to support separate group/send communications settings, the graphical system may translate the connection information between digital device nodes to independent group/send table entries in the device. The present approach appears to allow graphical connection between low cost bus devices and function control block devices in a simple block manner. This approach may extend the function block engine with high-powered IO, extra processing power, additional pre-designed ASIC or OEM function block requirements and powerful processing blocks that can be used for graphical IO, sensing, control, and processed data storage.

The present approach may be based on a modular or block approach to represent communications and connections between block entities in the control system environment, for example, an HVAC setting. Connections between blocks may represent local references between storage variables that allow the control blocks to share information, both from system IO, local calculation, and block IO. Previously, a connection to a low cost digital bus may have been represented through a separate subsystem, but this might have issues with implementation when this paradigm is extended beyond separate nodes. The present approach may permit an extension of communication to low cost digital bus subsystems, each with their own local memory reference scheme and allow connection and allocation of graphical connections to assign control block resources, additional remote low cost digital communication node systems (per N nodes), and additional communication structures to allow communications between a control block to node N, node N to node N, and node N to control block N. In addition, the communication scheme may allow source and destination blocks to be intermixed seamlessly to represent sensors, actuators, displays, and control block features. A unique feature could be that flat connections and abstraction of the information such that the digital communication bus node may contain new and unique IO and processing capabilities (data and methods—object abstractions) that allow significant IO (up to 32 in the example but easily extensible to much more) expansion, and unique processing and algorithm expansion of new block capabilities. For example, a new digital communication node device may support a graphical display, a unique energy calculation block to convert digital energy pulse and translate to a load shedding, virtually all embedded and hidden in an algorithm that is resident in the digital communication device node.

U.S. Pat. No. 7,653,459, issued Jan. 26, 2010, and entitled “VAV Flow Velocity Calibration and Balancing System”; U.S. Pat. No. 7,738,972, issued Jun. 15, 2010, and entitled “Modular Shared-Memory Resource Stage Driver System for Flexible Resource Linking in an Energy Conversion System”; U.S. Pat. No. 7,826,929, issued Nov. 2, 2010, and entitled “Low Cost Programmable HVAC Controller Having Limited Memory Resources”; U.S. Pat. No. 7,966,438, issued Jun. 21, 2011, and entitled “Two-Wire Communications Bus System”; Patent Application Pub. No. US 2008/0004725, published Jan. 3, 2008, and entitled “Generic User Interface System”; Patent Application Pub. No. US 2008/0010049, published Jan. 10, 2008, and entitled “Graphical Language Compiler System”; Patent Application Pub. No. US 2008/0016493, published Jan. 17, 2008, and entitled “System Level Function Block Engine”; Patent Application Pub. No. US 2009/0113037, published Apr. 30, 2009, and entitled “Interoperable Network Programmable Controller Generation System”; and Patent Application Pub. No. US 2010/0100583, published Apr. 22, 2010, and entitled “Flexible Graphical Extension Engine”; may be relevant patent documents, all of which are hereby incorporated by reference.

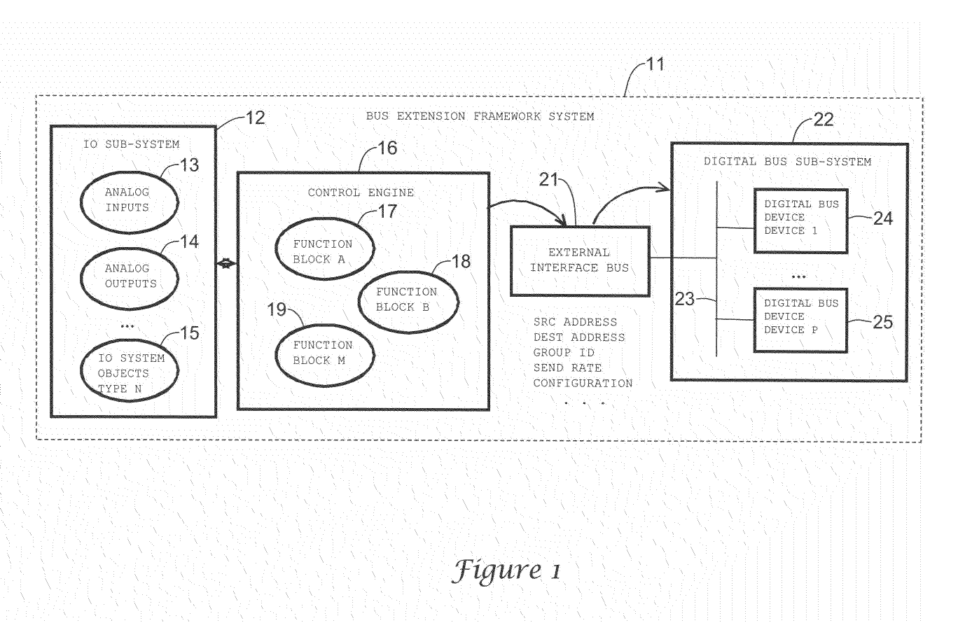

FIG. 1 is a diagram which shows a modular graphical bus extension framework system 11. It may be an individual system having a control engine 16 with individual block assignments such as function block 17 (block A), function block 18 (block B), and other function blocks through, for instance, function block 19 (block M). An analog and digital IO sub-system 12 may collect and normalize the Ins in a form that is directly readable to control engine 16. Sub-system 12 may have analog Ins 13, analog outputs, and other IO system objects through type N. Additional block sub-systems, including built-in functions and localized hardware objects, may be embedded in area 12 also.

A digital bus sub-system 22 may be communicated through a digital bus 23 using an individual bus node address. Individual points may be mapped using group and send table configuration information. Individual configuration information may be stored in configuration files in the main host node and individual copies may be stored in the digital bus node devices. Digital bus device 24 (device 1), and other digital bus devices through digital bus device 25 (device P) may be connected to the digital bus 23.

There may be an external interface bus 21 between control engine 16 and digital bus sub-system 22. Bus 21 may contain source (SRC) addresses, destination addresses, group identifications (ID's), send rates, configurations, and so forth.

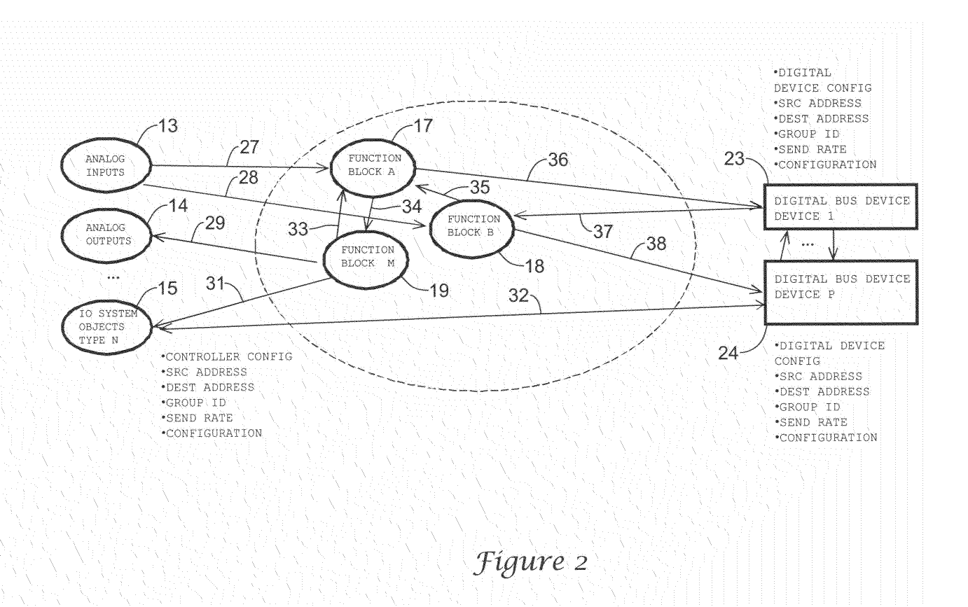

FIG. 2 is a diagram of a simplified connection in a block form that abstracts the connection and configuration information. Analog Ins 13 may go, for instance, to function blocks A and B (blocks 17 and 18) of control engine 16, as indicated by arrows 27 and 28, respectively. Analog outputs 14 may be received from, for instance, from function block M (block 19) of engine 16, as indicated by arrow 29. IO system objects of type N may go to IO sub-system 12 from, for instance, function block M (block 19) of engine 16, as indicated by arrow 31, and to and from, for instance, digital bus device P (device 24) of sub-system 22, as indicated by arrow 32. Information may, for instance, go from function block M (block 19) to function block A (block 17) via arrow 33, and vice versa via arrow 34. Another instance may be information going from function block B (block 18) to function block A (block 17) via arrow 35. Information may go from function block A (block 17) to digital bus device 1 (device 23) via an arrow 36 in one instance, from digital bus device 1 (device 23) to function block B (block 18) via an arrow 37 in another instance, and from block B (block 18) to digital bus device P (device 24) via an arrow 38 in still another instance. There may be many other propagations of information among the various entities of system 11. Information relating to the function blocks may regard controller configurations, SRC addresses, destination addresses, group ID's, send rates, configurations, and so forth. Information relating to the digital bus devices may regard digital device configurations, SRC addresses, destination addresses, group ID's, send rates, configurations, and so forth.

Some of the items described herein may be referred to by a respective trademark. A Spyder™ controller integrated with a Zio™ wall module, a Zelix™ actuator, a Sylk™ two wire polarity insensitive communications bus, and a Kingfisher™ (KF) layout configuration may be provided relative to a building control system as shown in some of the Figures discussed herein. The terms Spyder, Zio, Zelix, Sylk and Kingfisher are trademarks of Honeywell International Inc. Sylk and Kingfisher file designations may have suffixes of KFS and SLK, respectively. Spyder, Zio, Zelix, Sylk and Kingfisher are terms which are used in the context of the present description.

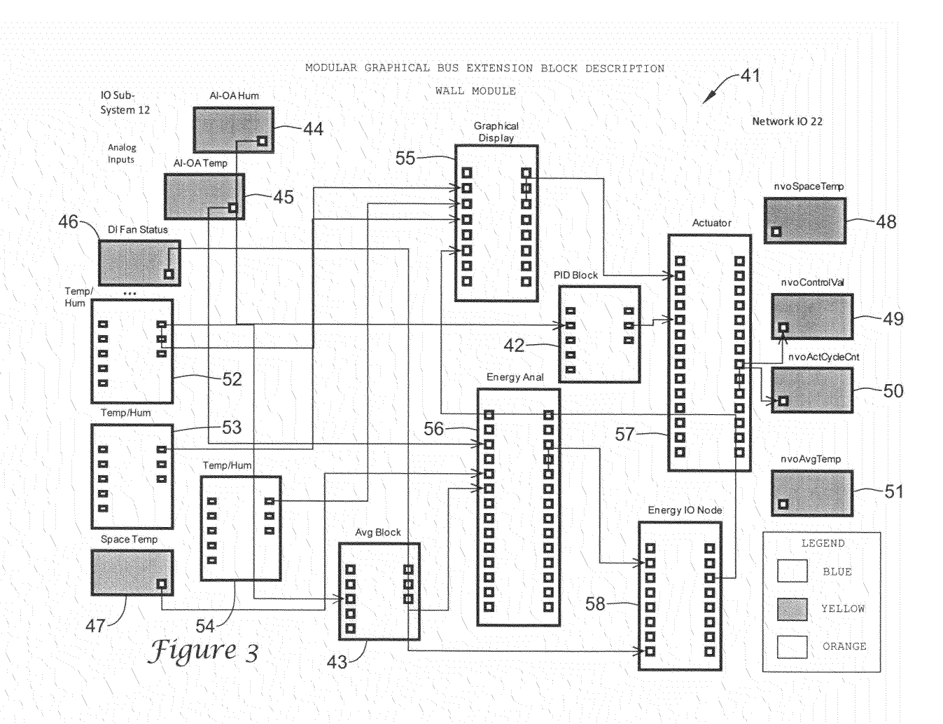

FIG. 3 is a diagram of a modular graphical graph extension block system 41. There may be an interrelationship of local function block control blocks 42 and 43 (blue), blocks 44-47 (yellow) of IO sub-system 12 and blocks 48-51 (yellow) of network IO sub-system 22. Digital control node blocks 52-58 (orange) may be Sylk devices system 41. Additional algorithms and graphical displays may also be shown as node devices (orange). Block 42 may be a “PID Block”, block 43 may be an “Avg Block”, block 44 may be an “AI-OA Hum”, block 45 may be an “AI-OA Temp”, block 46 may be a “DI Fan Status”, block 47 may be a “Space Temp”, block 48 may be an “nvoSpaceTemp”, block 49 may be an “nvoControlVal”, block 50 may be an “nvoActCycleCnt”, block 51 may be an “nvoAvgTemp”, block 52 may be a “Temp/Hum”, block 53 may be a “Temp/Hum”, block 54 may be a “Temp/Hum”, block 55 may be a “Graphical Display”, block 56 may be a “Energy Anal”, block 57 may be an “Actuator”, and block 58 may be an “Energy IO Node”.

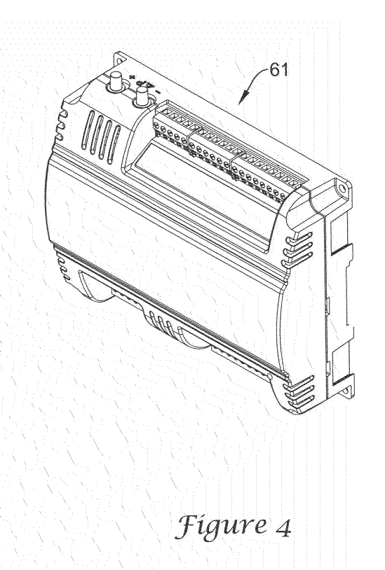

FIG. 4 is a diagram of a Spyder controller 61. Individual components of the controller may be noted. The controller may be a programmable unitary HVAC controller. It may provide robust HVAC programmable control. It may be available with a Lonworks and BACnet communications interface. The controller may support software applications such as VAV, CVAHU, a fan coil, and so on. For example, IOs may incorporate 6 UIs, 4 DIs, 3 AOs and 8 DOs, as an example. The building management interface/commissioning may incorporate WEBs/Webs AX.

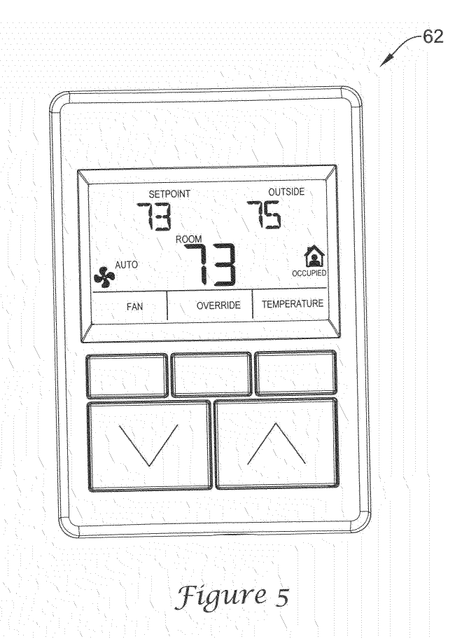

FIG. 5 is a diagram of a Zio LCD wall module 62. Individual components of a Zio may be noted. The module may incorporate LCD digital technology and compatible via a two-wire, polarity-insensitive bus with Spyder Sylk enhanced controllers. The module may offer flexibility and quick access to information. The Zio module may offer additional features such as scheduling and password capabilities.

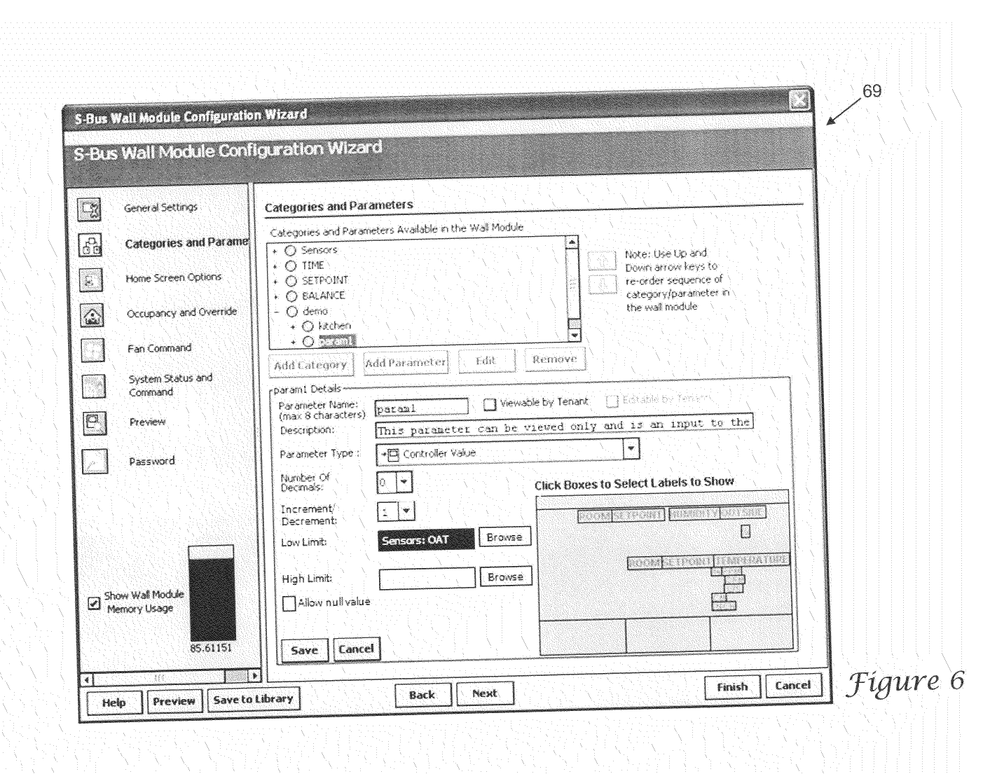

FIG. 6 is a diagram of a screen print 69 showing sample linked parameters relative to a Sylk bus wall module configuration wizard.

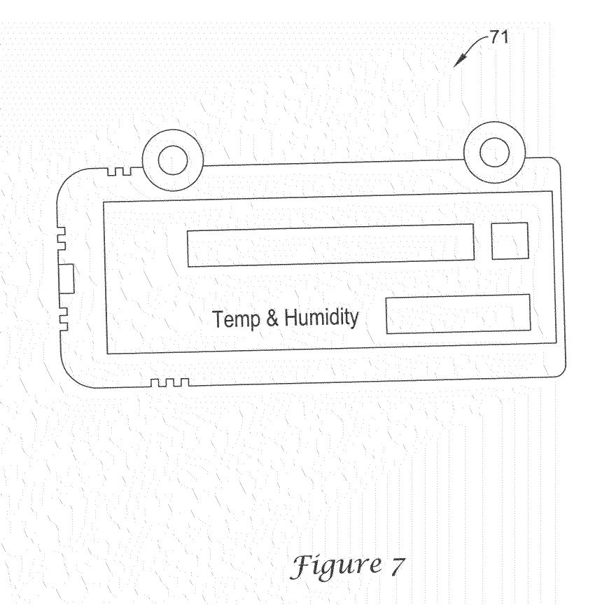

Individual components of a Sylk temperature and humidity sensor 71 of a diagram in FIG. 7 may be noted. There may be an enthalpy sensor for supply air (SA) or return air (RA) with a Sylk bus communication protocol C7400S1000. Sensor 71 may measure temperatures from minus 40 to plus 150 degrees F. and humidity from 11 to 89 percent RH with 5 percent accuracy. Sensor 71 may be selectable for supply air, return air, or outside air with a fixed Sylk address. Sensor may be configured for degrees F. or degrees C. The sensor may have a fixed public variable identification (PVID) temperature address at 0x2000 and humidity address at 0x2001. The sensor may be designed to communicate with, for instance, W7220™ and W7212™ economizers. “0x” indicates that the PVID number may be a hex number.

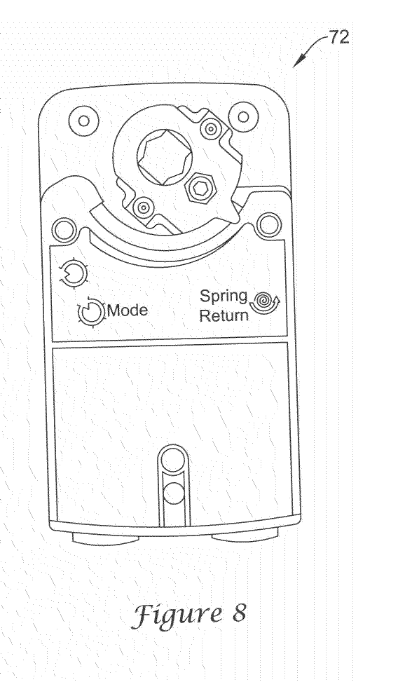

Individual components of a Sylk Zelix actuator 72 of a diagram in FIG. 8 may be noted. Actuator 72 may have a Sylk bus communication protocol. It may be a commandable position Sylk bus actuator. Actuator 72 may support Sylk bus information such as cycle count, override, actuator status, actual position, analog out value, framing errors, good Msgs, and backstops. Actuator 72 may use 24 VAC and Sylk bus communication.

Features and benefits of actuator 72 may incorporate a test mode for reduced test time, cycle count to manage end-of-life replacement, non-polarity sensitive Sylk hookup for reduced wiring complexity, fewer required cables for feedback and control available via Sylk, reduce install time, and have a need of less copper. The actuator may also provide status information such as stall, and over and under voltage reports.

Additional benefits of actuator 72 may incorporate improved accuracy, repeatability and resolution, and tighter and more consistent control. It may have programmable actuator speed from 30 to 180 seconds. Actuator 72 may have increased flexibility of operation. There may be up to five actuators 72 on a single bus. Actuator 72 may manage more complex applications with a simpler controller. Analog outputs (AO) are not necessarily used. There may be an on board analog output for simple control of a second modulating actuator. There may be an auxiliary switch (aux switch) which can be controlled manually or via Sylk. It may have override switches relative to Sylk.

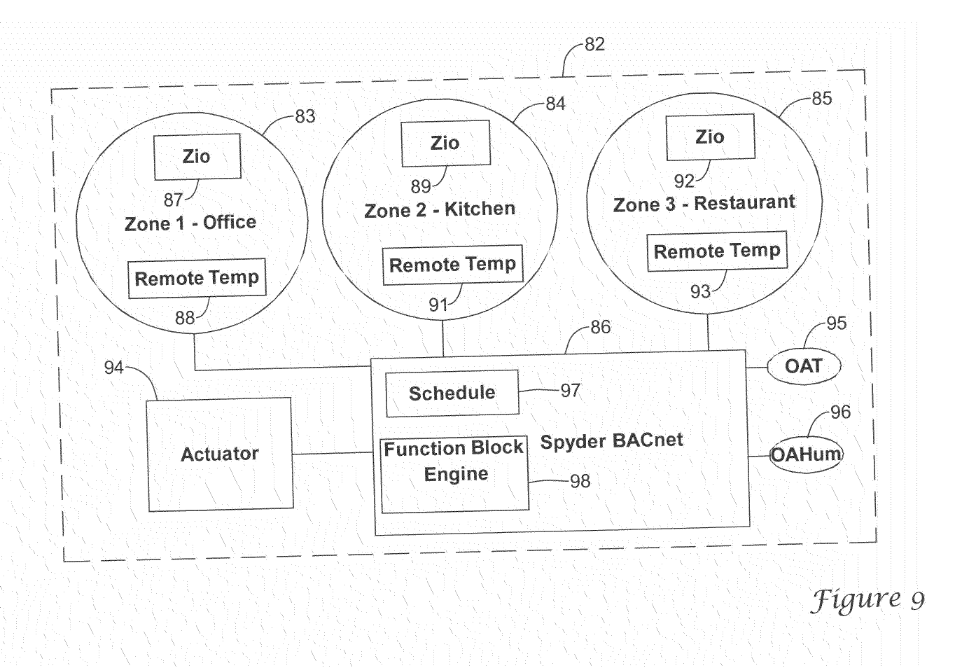

FIG. 9 is a diagram of an example of a restaurant as a system 82 with integration. A zone 1 having an office 83 may be connected to a Spyder BACnet 86. Office 83 may have a Zio 87 and a remote temperature sensor and indicator 88. A zone 2 having a kitchen 84 may be connected to the Spyder BACnet 86. Kitchen 84 may have a Zio 89 and a remote temperature sensor and indicator 91. A zone 3 having a restaurant 85 may be connected to the Spyder BACnet 86. Restaurant 85 may have a Zio 92 and a remote temperature sensor and indicator 93. An actuator 94 may be connected to the Spyder BACnet 86. An outside air temperature sensor (OAT) 95 and an outside air humidity sensor 96 may be connected to the Spyder BACnet 86. A schedule 97 and a function block engine 98 may be associated with and connected to the Spyder BACnet 86. Programming, control and averaging temperatures of the zones may be done at the office. Each of the zones 83, 84 and 85 may have its own address. Each terminal of a device for a connection may have a public variable identification (PVID).

Components for a Spyder system implementation, such as in a test, may incorporate Spyder BACnet firmware 6.20.X with Zio schedule enhancements, Zio development firmware on Zio HW (3×), Fishsim 7.0.34, WM tool 31, development Zelix Actuator and a Sylk Sensor C7400S1000 HW (3×). The components may further incorporate a USB Sylk dongle, a quick connect Sylk/24VAC junction box, KFS/Sylk file library on a Fishsim teamroom, demo files available on a K drive (e.g., Spyder BACnet SoftwareTest) and Zio user application manual (“Cookbook”) on Xpedio.

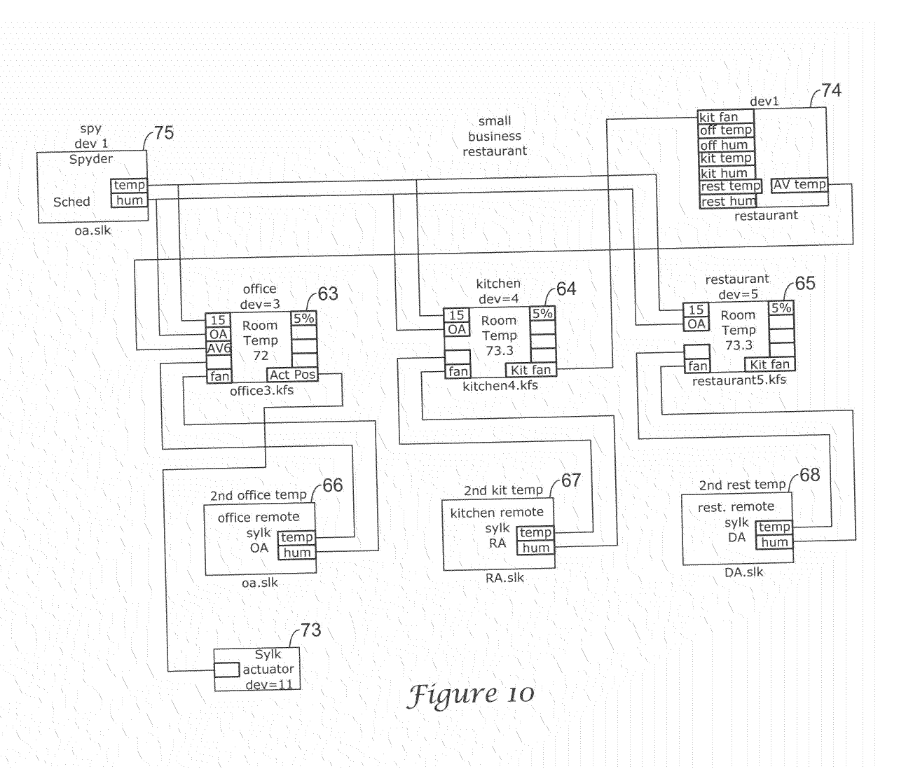

FIG. 10 is a schematic diagram of some of the components of the restaurant system. Wall module devices 63, 64 and 65, regarded as devices 3, 4 and 5, may be situated in an office, kitchen and restaurant, respectively. They may be regarded as Kingfisher devices having addresses of office3.kfs, kitchen4.kfs and restaurant5.kfs, in that order. The devices may be connected to the Sylk bus. There may be second office, kitchen and temperature remote sensor devices 66, 67 and 68, which can have device numbers 8, 9 and 10, respectively. They may be regarded as Sylk devices having addresses oa.slk, ra.slk and da.slk, in that order, being connected to the Sylk bus. A Sylk actuator 73, having a device number 11, may be connected to wall module device 63. A wall module 74, device 1, may be connected to the Sylk bus. Module 74 may indicate temperature and humidity of the office, kitchen and restaurant. Module 73 of the office may indicate the average temperature of the office, kitchen and restaurant. The Sylk bus may be connected to a Spyder controller 75.

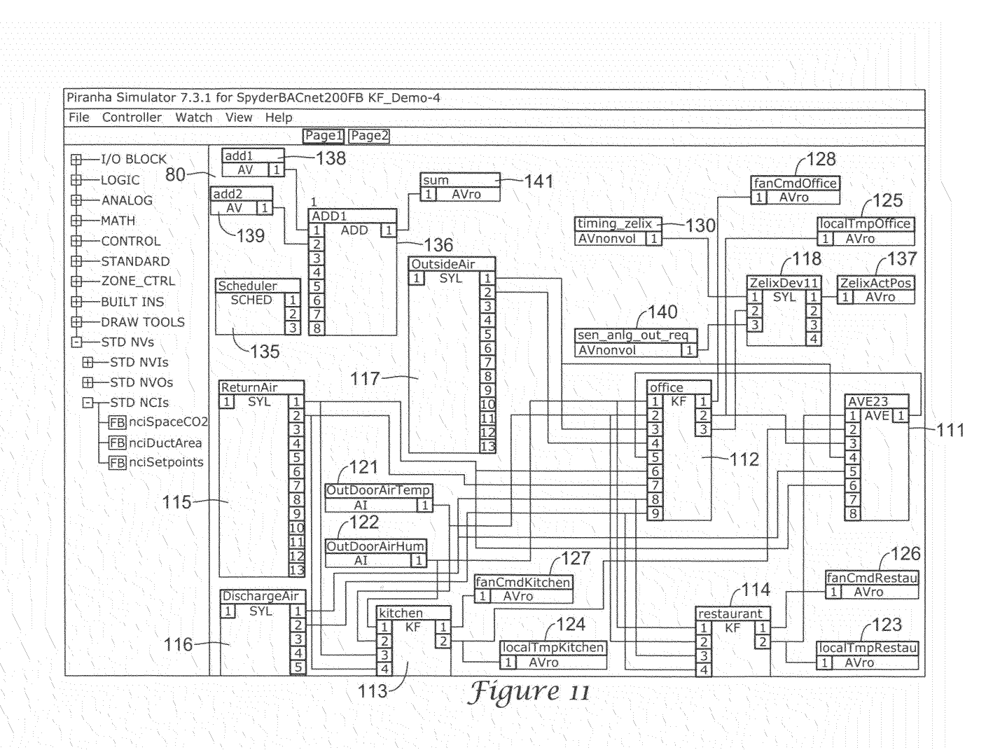

FIG. 11 is a function block like screen 80 in which the restaurant system is shown with block-like symbols with lines showing connections among the symbols. Average (AVE) block 111 may be a function block. Symbols 112, 113 and 114 may represent Kingfisher devices. Sylk devices 115, 116 and 117, respectively, may be provided for return air, discharge air and outside air temperatures and humidity indications. A Zelix actuator 118 for operating or controlling a mechanism may be connected to office device 112. Actuator 118 may have an input from office 112, inputs from items 130 and 140, and an output to an item 137. Components 121, 122, 123, 124, 125, 126, 127 and 128 may relate to temperature and humidity sensing, fan mechanisms and other items useful to the system. Components 131, 132 and 133 may relate to Zelix device 118. A scheduler 135 may be connected into the system as desired. One or more function blocks, such as function block 136 for addition with inputs 138 and 139 and output 141, may be brought in and implemented as desired.

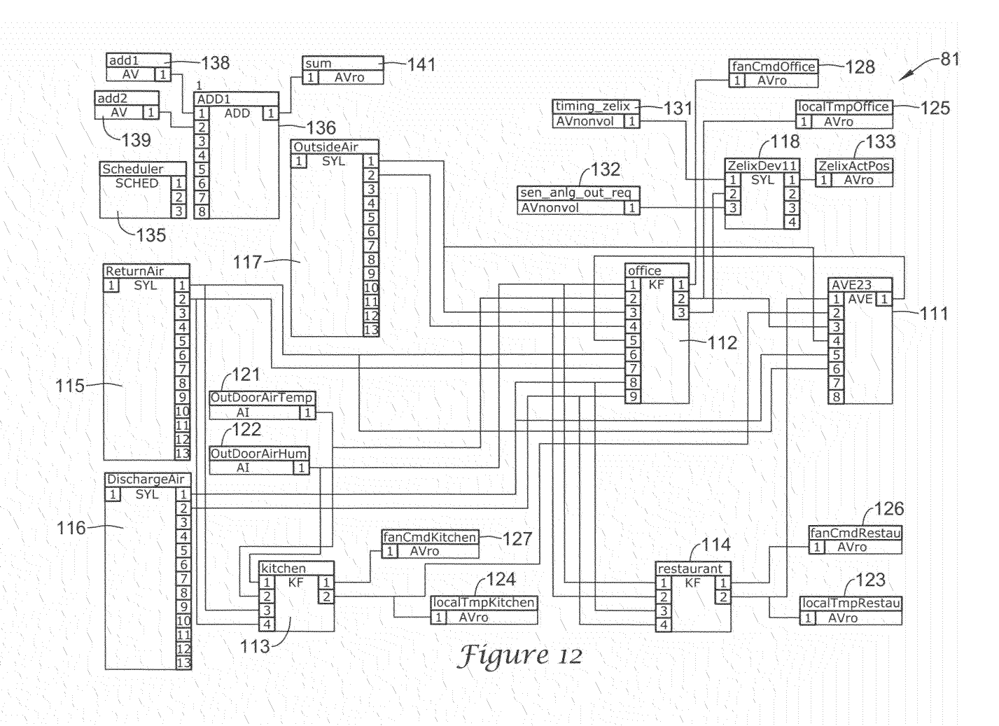

FIG. 12 is a diagram of a screen 81 similar to the diagram of screen 80 of FIG. 11 but with some identification of the inputs and outputs at the symbols. Generally, in FIGS. 11 and 12, the inputs on one side of a representative symbol and outputs on the other side of the symbol may be numbered sequentially from top to bottom.

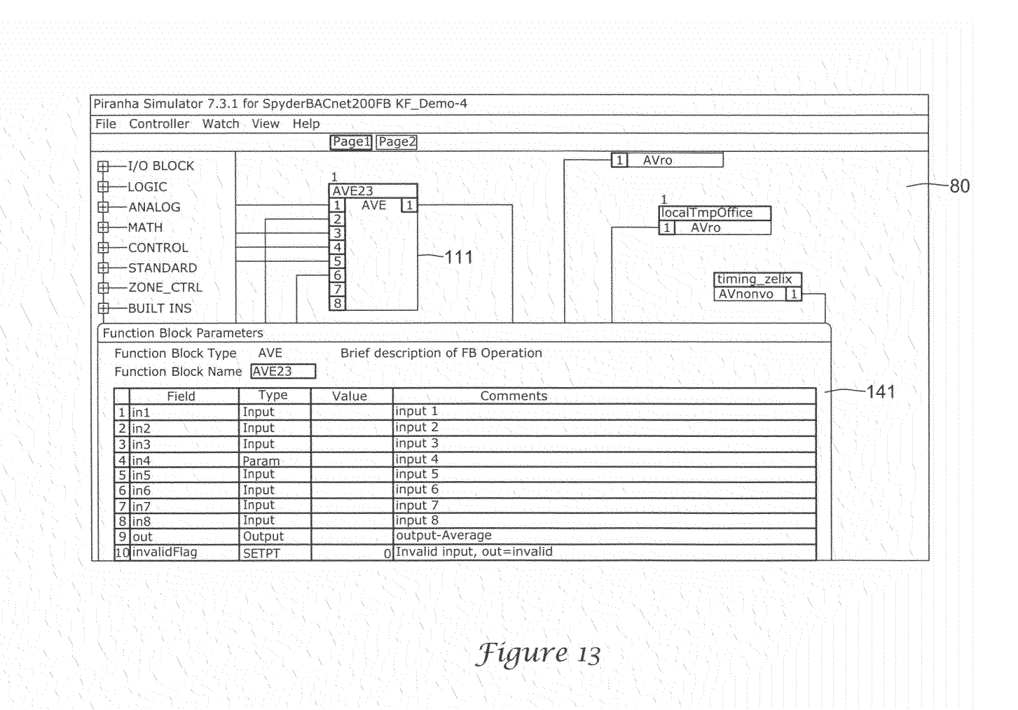

FIG. 13 is a diagram which may resemble an implementation for a function block for average 111 (AVE) shown in screen 80 of a diagram in FIG. 11. One may right-click on the AVE symbol 111 to get a screen 141 and then click on Edit to get details of the function parameters for the AVE function block 111. Attaining screen 141 may be regarded as an example of an under-the-hood indication of details.

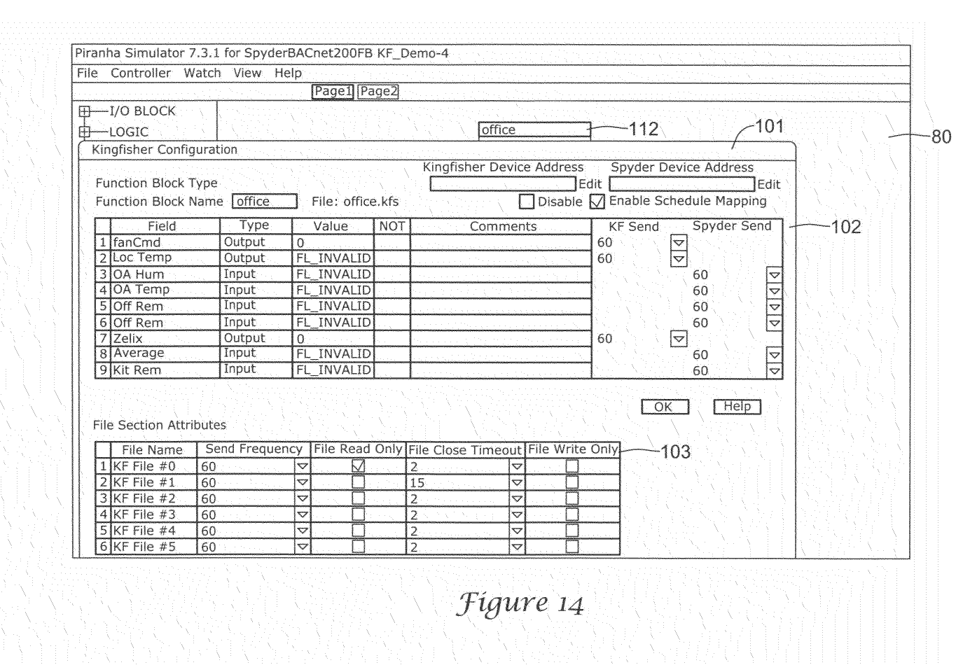

FIG. 14 is a diagram which may resemble an implementation for an office 112 in the system shown in screen 80 of the diagram in FIG. 11. One may right-click on the office symbol to get a screen 101 and then click on Edit to get details of a Kingfisher configuration diagram pertaining to the office. Screen 101 for office 112, may also be regarded as an example of an under-the-hood indication of details of the pertinent device, and respective Ins and outputs with the field, type, value and so on, as shown in a table 102. Also, file section attributes may be indicated in a table 103. There may other forms of an under-the-hood indication of details of a device which are not necessarily displayed in, for instance, a modular graphical bus extension block description which incorporates the device.

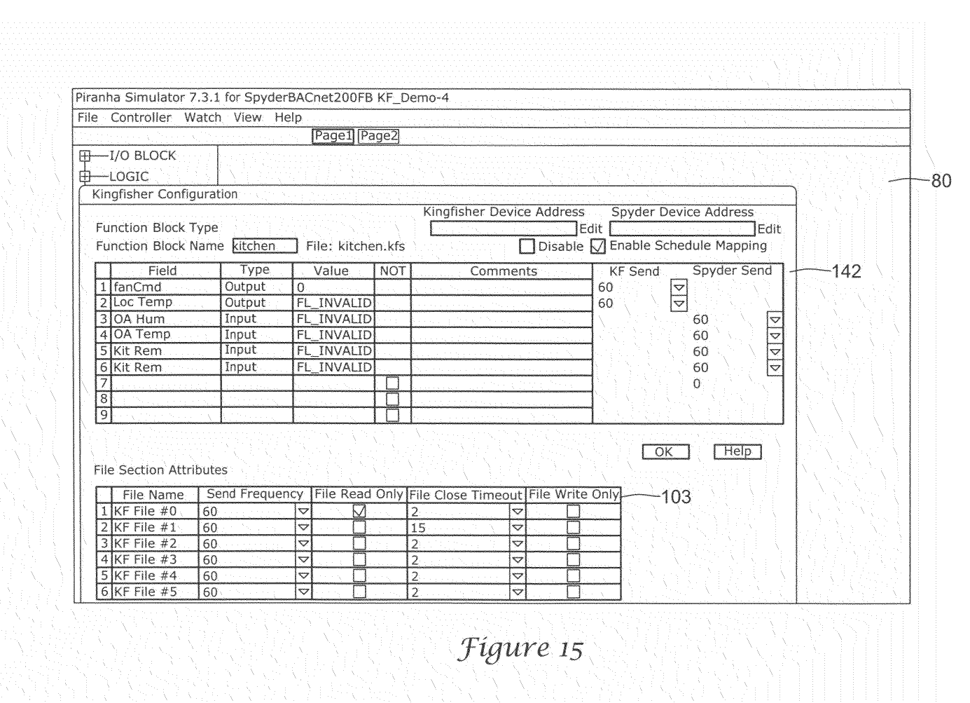

FIG. 15 is a diagram of a screen 142 of details for a Kingfisher configuration of the kitchen device 113. These details may be obtained in the same manner as for the details of AVE function block 111 and office 112 as described relative to FIGS. 13 and 14, respectively.

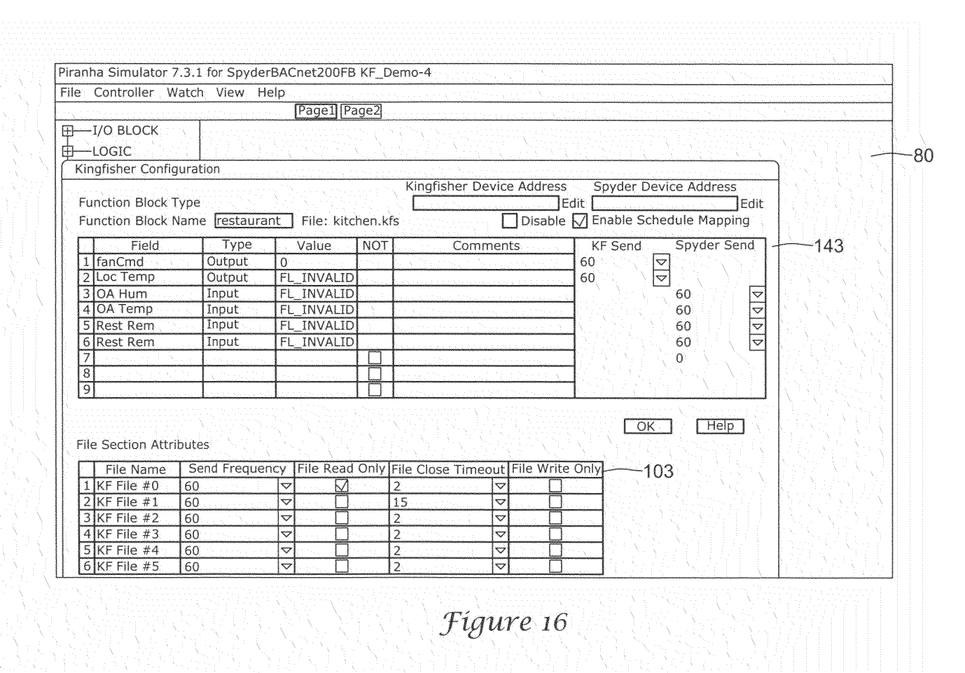

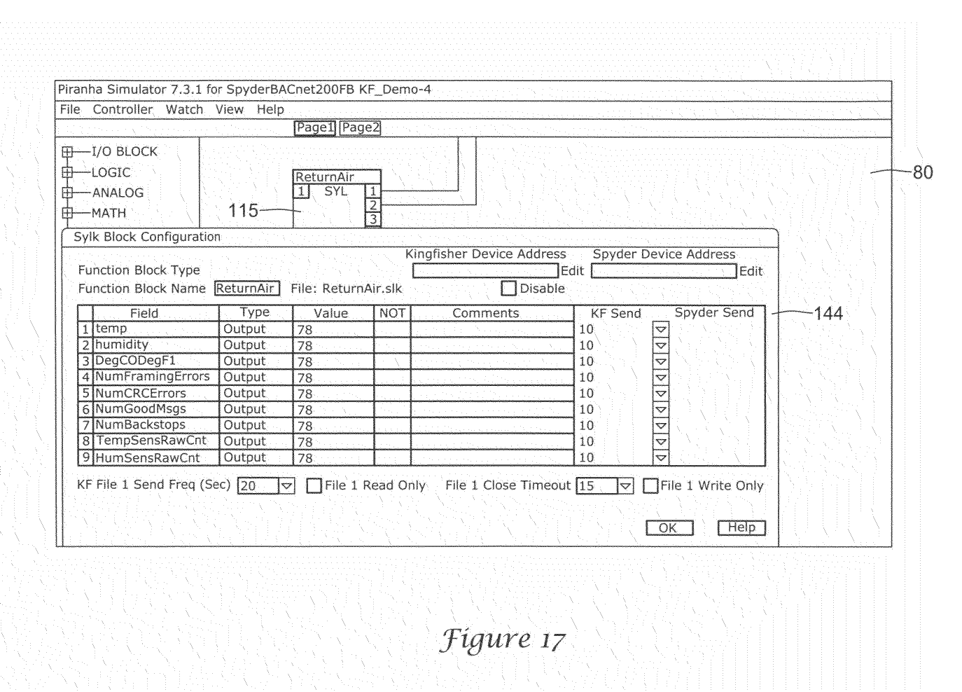

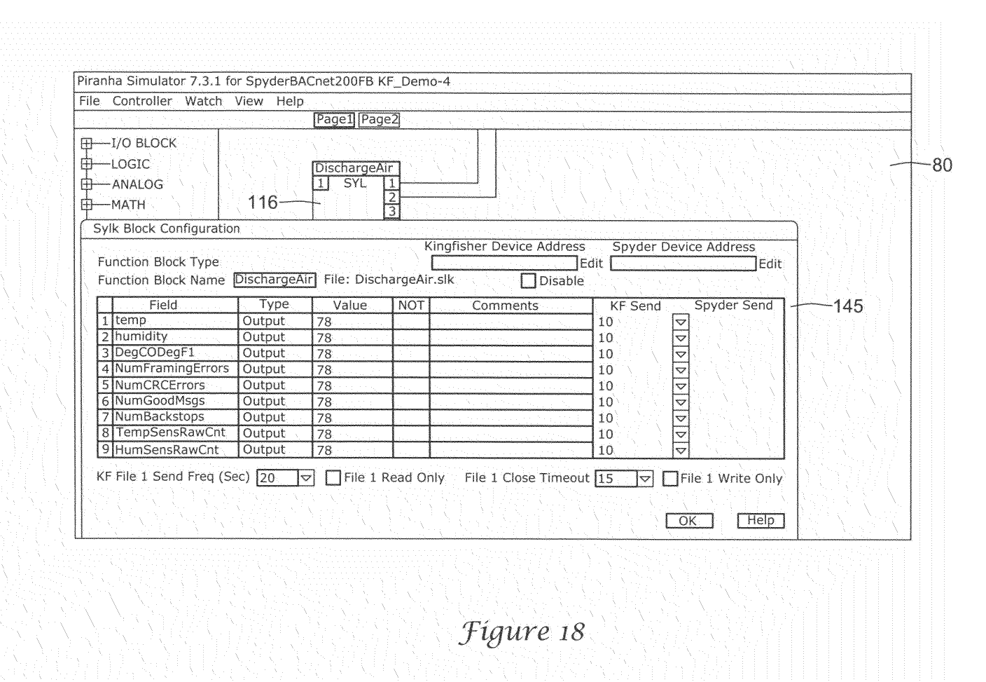

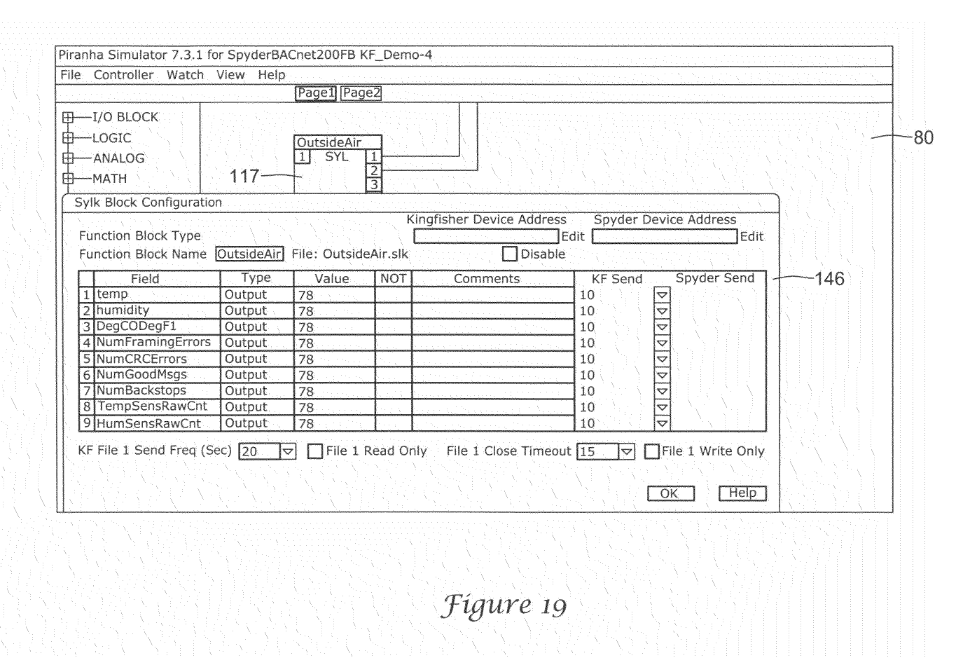

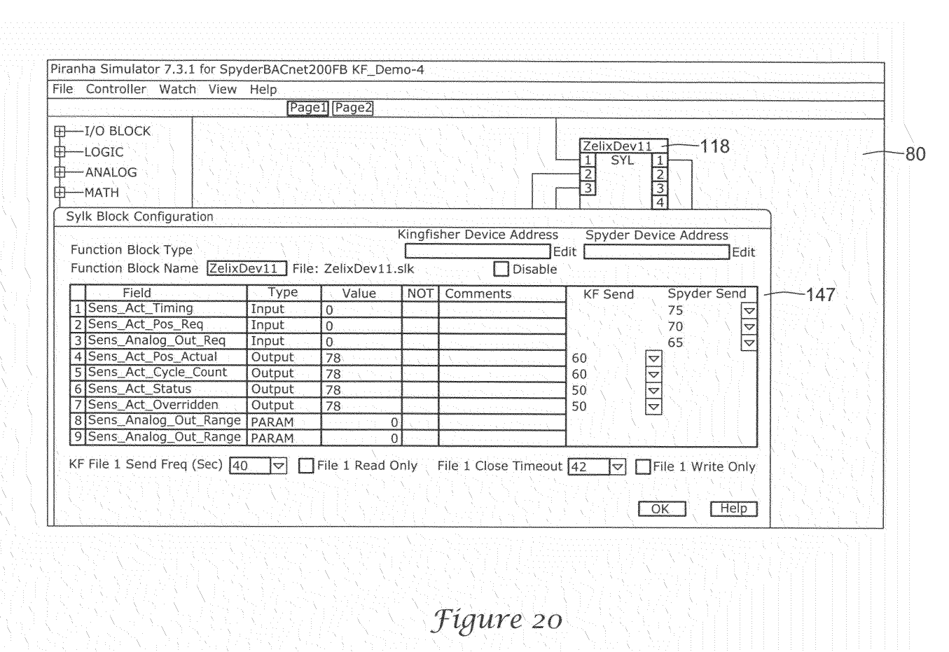

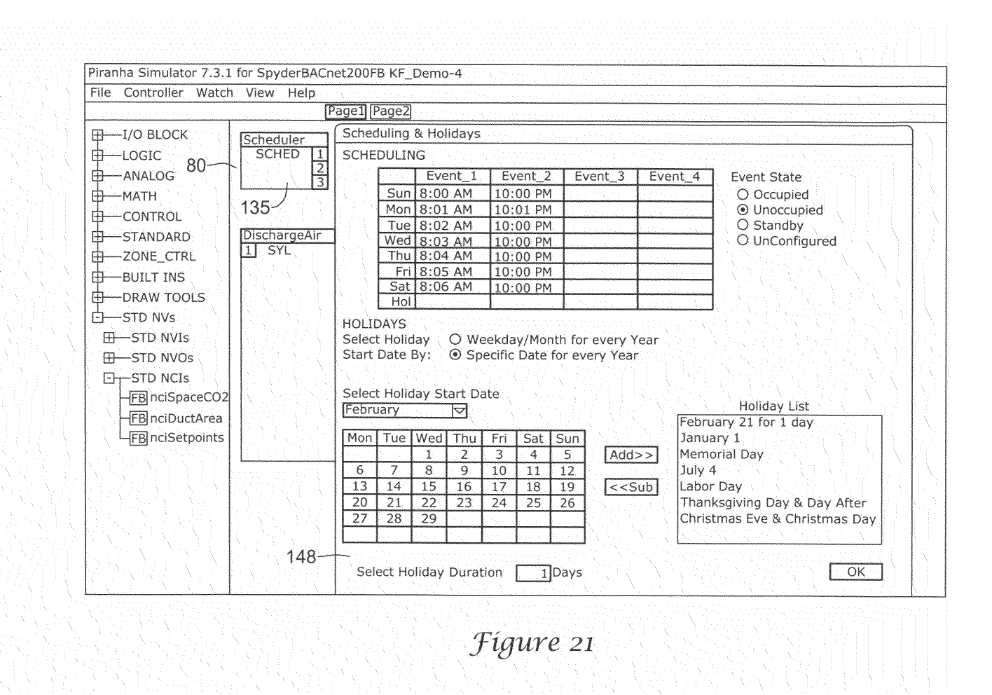

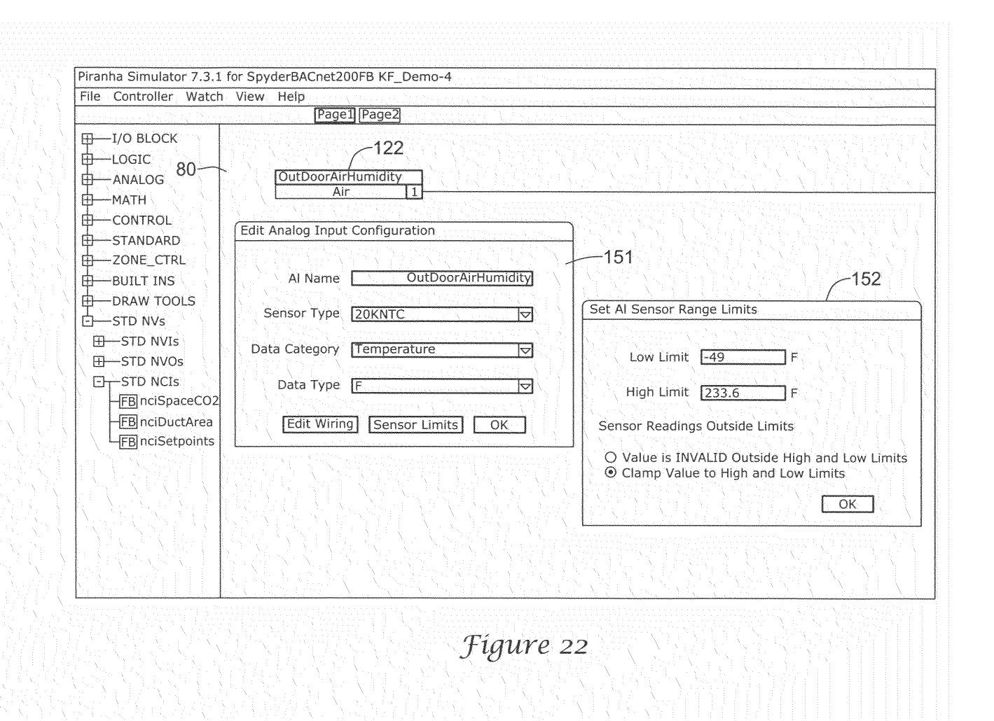

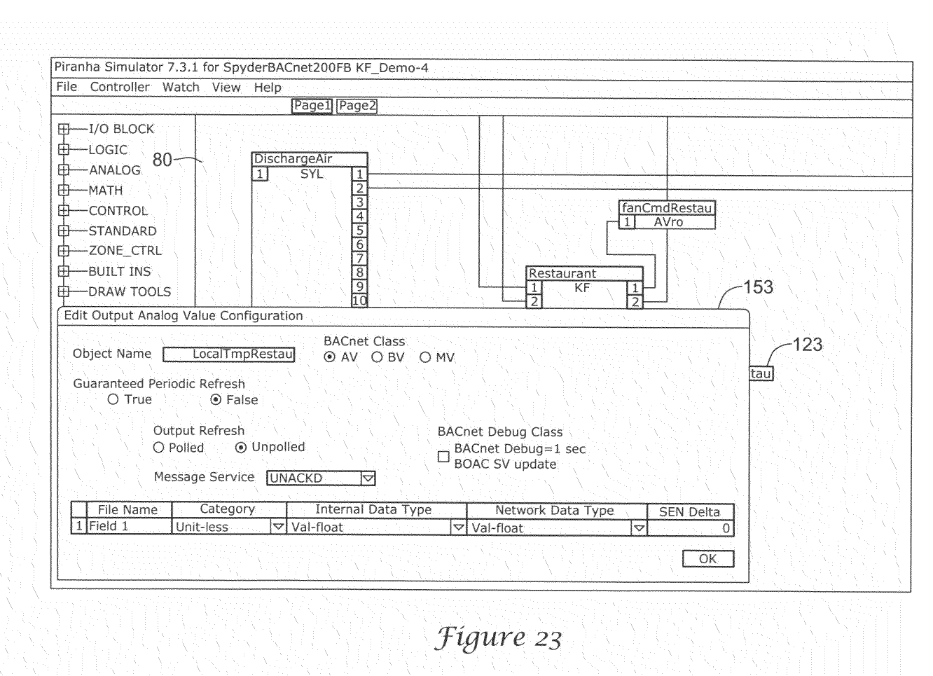

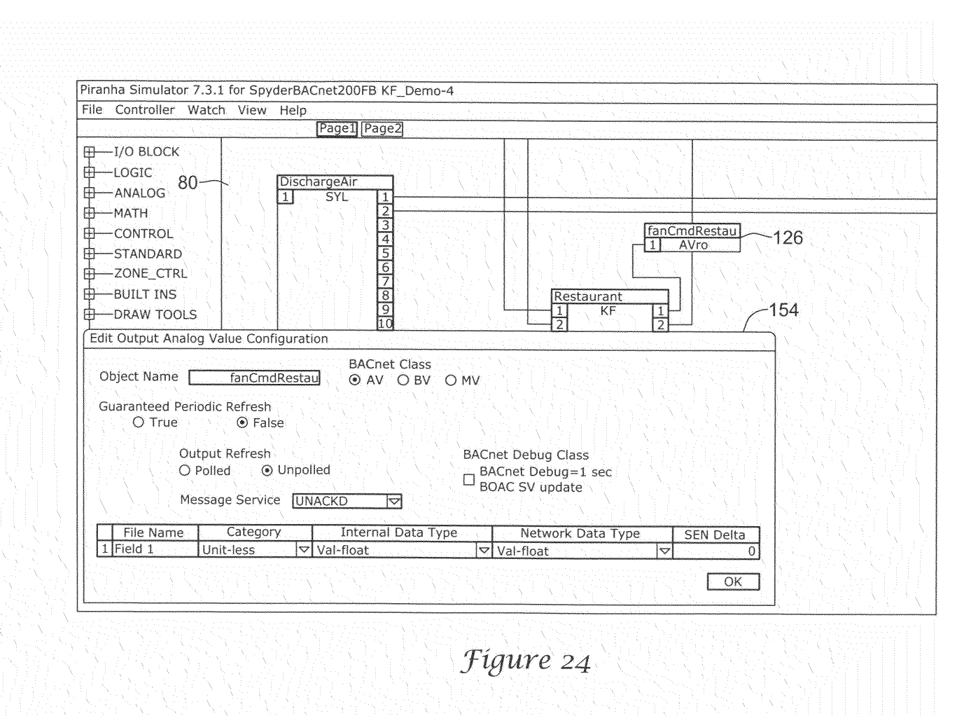

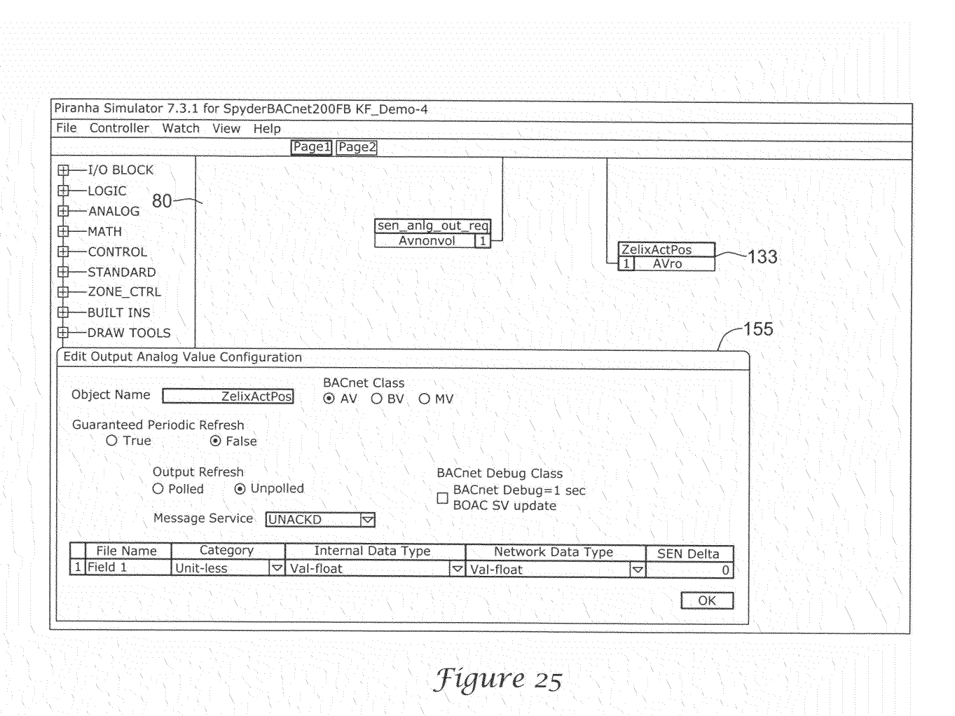

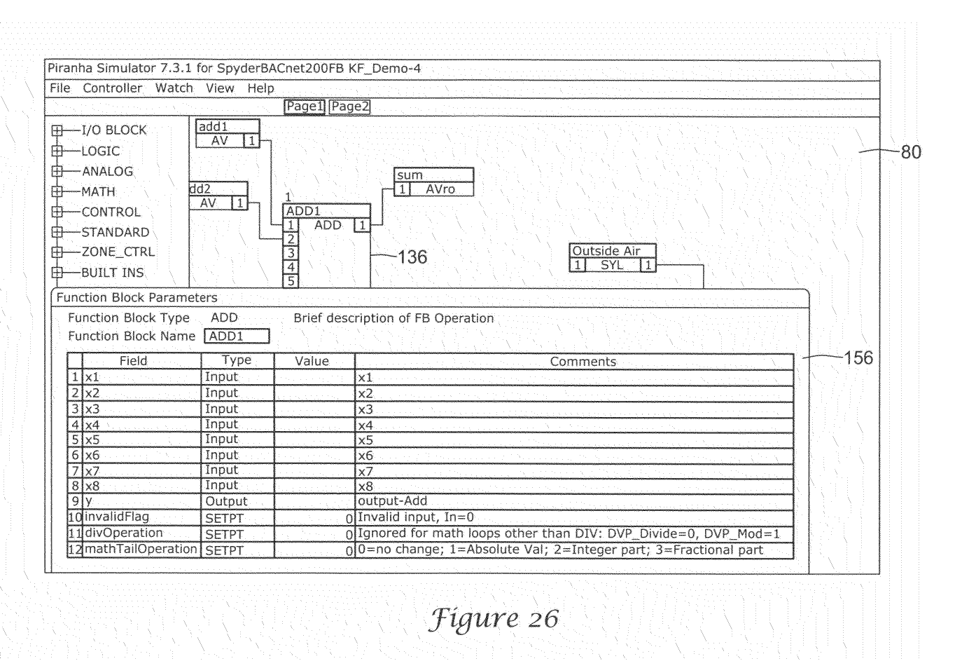

Screens with details for the components noted in FIGS. 16-26 may be obtained in the same manner as screens 141, 101 and 142 in FIGS. 13-15, respectively. FIG. 16 is a diagram of a detail screen 143 of a Kingfisher configuration for restaurant device 114. FIG. 17 is a diagram of a detail screen 144 of a Sylk block configuration for return air device 115. FIG. 18 is a diagram of a detail screen 145 of a Sylk block configuration for discharge air device 116. FIG. 19 is a diagram of a detail screen 146 of a Sylk block configuration for outside air device 117. FIG. 20 is a diagram of a detail screen 147 of a Sylk block configuration for Zelix actuator device 118. FIG. 21 is a diagram of a detail screen 148 of scheduling and holidays for scheduler device 135. FIG. 22 is a diagram of detail screens 151 and 152 for editing an analog In configuration and setting analog In sensor range limits, respectively, for outdoor air humidity device 122. FIG. 23 is a diagram of a detail screen 153 for editing an output analog value configuration for the local temperature mechanism 123. FIG. 24 is a diagram of a detail screen 154 for editing an output analog value configuration for the restaurant fan command mechanism 126. FIG. 25 is a diagram of a detail screen 155 for editing an output analog value configuration for a Zelix actuator position indication mechanism. FIG. 26 is a diagram of a detail screen 156 of function block parameters for an addition function block 136. Other detail screens may be obtained in a similar way for other devices, components, mechanisms and other items represented by symbols in the system diagram described herein.

Features of the present system may incorporate the following items. Each Zio (3×) may read its own temperature or a respective remote temperature (Sylk temp/hum) in its zone. Each Zio (3×) may read the master schedule in the Spyder. The Spyder may collect each Zio zone temperature and additional Sylk zone temperatures and average them and then display the average temperature on the office Zio (an average of six zones). The office Zio may read all temperatures across all zones (six individual temperatures). The office Zio may command an actuator from the screen of the system. The outside air temperature (OAT) and outside air humidity (OA Hum) may be sent from physical sensors on the Spyder to each home screen on each of the three Zios.

In summary, a Zio development environment may allow a preview of Spyder/Zio scheduling/Sylk system sensor/actuator remote IO architecture using engineering configuration tools. There may be good interoperability between multiple LOB NPI projects with coordination. Additional pull through, combination, reuse, OEM (original equipment manufacturer) and customer opportunities may be implemented using combinations of the Spyder, Sylk sensors/actuators/relay IO, thermostat 2 piece, thermostat one-piece, and the Zio.

The AVE block in FIG. 11 may be a device 2. The listing below has hex numbers for PVID's as indicated by a preceding “0x”. A unique identifier may combine the device number (e.g., 2) and a PVID (e.g., 000A) to result in “2:000 A”. The following indicates a representative PVID Memory allocation for device 2.

To recap, a bus extension framework system may incorporate a heating, ventilation and air conditioning (HVAC) host controller, a communications bus connected to the HVAC host controller, and one or more devices connected to the communications bus. The HVAC host controller may incorporate a computational engine and a storage mechanism. The communications bus may be a two wire bus. Each of the one or more devices may have a fixed function, configurable function or programmable function. The one or more devices may have a temperature sensor and/or a humidity sensor. The storage mechanism may have a proxy file incorporating connection and configuration information for each of the one or more devices. The two wire bus may be a multi-drop bus. The host controller may be for a building management system.

The proxy file may incorporate a plurality of sections for virtually all of the one or more devices. A device file may incorporate one or more sections in the proxy file for each device of the one or more devices. A section of the device file may have a group/send table. The group/send table may have public variable identifications (PVID's).

The host controller may further incorporate an input/output mechanism connected to the computational engine and to the communications bus. The input/output mechanism may have a physical input/output and network input/output. The physical input/output may have analog inputs, analog outputs, and/or input/output system objects.

The computational engine may incorporate a function block engine, personal computer, a processor, or other computational mechanism. If the computational engine incorporates a function block engine, then the function block engine may have one or more function blocks. The storage mechanism may have a volatile and/or non-volatile memory. The volatile and/or non-volatile memory may incorporate a random access memory, flash memory, and/or a hard drive.

A device incorporating a fixed function device may be a temperature sensor, a humidity sensor, an actuator, or a user interface module. A programmable function device may be a function block engine. The function block engine may have canned applications. The function block engine may be virtually fully programmable. The host controller may incorporate a function block engine.

A section of a device file may further incorporate, for an input/output mechanism object, an input/output mechanism object, a configuration, a source address, a destination address, a group identification, and/or a send rate. The section of the device file may further incorporate, for a message from the function block engine, a source address, destination address, group identification, send rate and/or a configuration. The section of the device file may further incorporate, for a communications bus device, a configuration, source address, a group identification, and/or a send rate.

A connection from a sending device to a recipient device may incorporate information having a device designation and a public variable identification of the recipient device. The connection may further incorporate information having a device designation and a public variable identification of the sending device. The group/send table may be updated with the information upon a making the connection.

The system may further incorporate an under-the-hood display of a configuration of a particular device, incorporating inputs, outputs, parameters, setpoints, data and other information of the particular device.

An approach for a modular graphical bus extension of a framework may incorporate providing a heating, ventilation and air conditioning (HVAC) host module, connecting a bus to the HVAC host module, and connecting one or more device modules to the bus. The HVAC host module may incorporate a function block engine, a storage mechanism connected to the function block engine, a physical input/output system connected to the function block engine, and a network input/output system connected to the function block engine. The function block engine may have one or more function blocks. The one or more device modules may incorporate one or more sensors, displays, indicator devices, relays, wall modules, processing units, and/or actuators. A proxy file may be held by the storage mechanism. The proxy file may have configuration and/or communication data for virtually all of the device modules.

The bus may be a two-wire bus. The two-wire bus may be polarity-insensitive. The bus may be a multi-drop bus.

The physical IO system may have one or more analog inputs and/or analog outputs. The network input/output system may have one or more objects.

The proxy file may incorporate a plurality of sections for virtually all of the one or more devices. A device file may have one or more sections in the proxy file for each device of the one or more devices. A section of the device file may have a group/send table. The group/send table may have public variable identifications.

A bus extension framework system may incorporate a heating, ventilation and air conditioning (HVAC) host controller, a communications bus connected to the HVAC host controller, and one or more device modules connected to the communications bus. The HVAC host controller may incorporate a function block engine, a storage mechanism connected to the function block engine, and an input/output system connected to the function block engine. The function engine may have one or more function blocks. The storage mechanism may store a proxy file incorporating configuration and/or communication information for virtually all of the one or more device modules.

The one or more device modules may incorporate one or more sensors, displays, indicator devices, relays, wall modules, special processing units, and/or actuators. A sensor may be a temperature sensor and/or a humidity sensor. A wall module may incorporate a thermostat and/or a processor.

The proxy file may have a group/send table for virtually all of the device modules. The proxy file further may incorporate under-the-hood detailed information about device modules, function blocks, components of input/output systems and connections between them. Detailed information about device modules, function blocks, components of input/output systems and connections between them may be provided upon an on-the-fly up request while the system is operating. The communications bus may be a multi-drop polarity-insensitive bus.

********

,,,PVID Group Table Updated ,3,C3C122

,,,PVID Send Table Updated

### ,19,0013110020001411012001041000200105100120020B000020

For example

3:1113<-10:2000

In the send table updated the PVID are byte swapped so 1113 is represented as 1311 and 2000 is represented as 0020

The send table format may be group id, destination pvid, source pvid so the example is group 00, pvid 1311 and pvid 2000 which corresponds to 0013110020 in the PVID send table list

The group table may have 3 entries c3 c1 and 22; group 0 may be a update rate c=12=12×5=60 seconds and destination address is 3—

00131100200

Discussion on FIG. 12—an example may be for Discharge air.temp as follows:
Add Connection 17 SrcLoop=16 SrcOut=0 (DischargeAir.temp) DestLoopNum=8 Destln=7 (office.Rest Rem)
Add Connection 24 SrcLoop=16 SrcOut=0 (DischargeAir.temp) DestLoopNum=11 Destln=2 (restaurant.Rest Rem)
Add Connection 36 SrcLoop=16 SrcOut=0 (DischargeAir.temp) DestLoopNum=23 Destln=4 (AVE23.in5)

The following discussion may trace the outputs of (Sylk address 10) Sylk block 16 (DischargeAir) to 3 inputs: block 8 input 7 (sylk address 3 (KF block) office.Rest Remote), block 11 input 2 (sylk address 1) restaurant.Rest rem) and Block 23 input (function block AVE23.in5).

Each of these connections may be assembled in the file dischargeAir.slk in the PVID group table and PVID send table.

Inside the “sylk device group tables and sylk send tables, one may note:

### Group and Send Table Information

Sylk Device Group tables

| Unique | Src | Local | Group | Group | Group |
|---|---|---|---|---|---|
| Grp ID | Addr | Grp ID | Freq | Seconds | DestAddr |
| 27 | 10 | 0 | 12 | 60 | 3 |
| 28 | 10 | 1 | 12 | 60 | 1 |
| 29 | 10 | 2 | 2 | 10 | 2 |

Sylk Send tables

| | | | | | | | | | |
|---|---|---|---|---|---|---|---|---|---|
| Src Dev | Send | Group | Local | Dest | | Source | | Freq | Dest |
| Addr | ID | ID | Grp ID | PVID | <− | PVID | Freq | in Sec. | Addr |

| | | | | | | | | |
|---|---|---|---|---|---|---|---|---|
| 10 | 114 | 27 | 0 | 3:1113 | 10:2000 | 12 | 60 | 3 |
| 10 | 115 | 27 | 0 | 3:1114 | 10:2001 | 12 | 60 | 3 |
| 10 | 116 | 28 | 1 | 1:1004 | 10:2000 | 12 | 60 | 1 |
| 10 | 117 | 28 | 1 | 1:1005 | 10:2001 | 12 | 60 | 1 |
| 10 | 118 | 29 | 2 | 2:000B | 10:2000 | 2 | 10 | 2 |

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A bus extension framework system, comprising:
a heating, ventilation and air conditioning (HVAC) host controller;
a communications bus connected to the HVAC host controller; and
one or more devices connected to the communications bus; and
wherein:
the HVAC host controller comprises:
a computational engine; and
a storage mechanism;
the communications bus is a two wire bus;
each of the one or more devices comprises a fixed function, configurable function or programmable function;
the one or more devices comprise a temperature sensor and/or a humidity sensor; and
the storage mechanism comprises a proxy file incorporating connection and configuration information for each of the one or more devices.

2. The system of claim 1, wherein:
the proxy file comprises a plurality of sections for virtually all of the one or more devices;
a device file comprises one or more sections in the proxy file for each device of the one or more devices;
a section of the device file comprises a group/send table; and
the group/send table comprises public variable identifications.

3. The system of claim 1, wherein the host controller further comprises:
an input/output mechanism connected to the computational engine and to the communications bus; and
wherein the input/output mechanism comprises:
a physical input/output; and
a network input/output; and
wherein the physical input/output comprises analog Ins, analog outputs and/or input/output system objects.

4. The system of claim 1, wherein:
the computational engine comprises a function block engine or personal computer; and
if the computational engine comprises a function block engine, then the function block engine comprises one or more function blocks.

5. The system of claim 2, wherein:
a device comprising a fixed function device can be a temperature sensor, a humidity sensor, an actuator, or a user interface module;
a programmable function device can be a function block engine;
the function block engine comprises canned applications;
the function block engine is virtually fully programmable; and
the host controller can comprise a function block engine.

6. The system of claim 1, wherein the two wire bus is a multi-drop bus.

7. The system of claim 2, wherein:
a section of a device file further comprises, for an input/output mechanism object, an input/output mechanism object, a configuration, source address, a destination address, a group identification, and/or a send rate;
the section of the device file further comprises, for a message from the function block engine, an source address, destination address, group identification, send rate and/or a configuration; and
the section of the device file further comprises, for a communications bus device, a configuration, source address, group identification, and/or a send rate.

8. The system of claim 2, wherein:
a connection from a sending device to a recipient device comprises information incorporating a device designation and a public variable identification of the recipient device;
the connection further comprises information incorporating a device designation and a public variable identification of the sending device; and
the group/send table is updated with the information upon a making the connection.

9. The system of claim 1, wherein the host controller is for a building management system.

10. The system of claim 2, further comprising an under-the-hood display of a configuration of a particular device, incorporating Ins, outputs, parameters, setpoints, data and other information of the particular device.

11. A method for a modular graphical bus extension of a framework, comprising:
providing a heating, ventilation and air conditioning (HVAC) host module;
connecting a bus to the HVAC host module; and
connecting one or more device modules to the bus; and
wherein:
the HVAC host module comprises:
a function block engine;
a storage mechanism connected to the function block engine;
a physical input/output system connected to the function block engine; and
a network input/output system connected to the function block engine;
the function block engine comprises one or more function blocks;
the bus is a two-wire bus;
the one or more device modules comprise one or more sensors, displays, indicator devices, relays, wall modules, processing units, and/or actuators;
a proxy file is held by the storage mechanism; and
the proxy file comprises configuration and/or communication data for virtually all of the device modules.

12. The method of claim 11, wherein the two-wire bus is polarity-insensitive.

13. The method of claim 12, wherein the bus is a multi-drop bus.

14. The method of claim 12, wherein:
the physical IO system comprises one or more analog inputs and/or analog outputs; and
the network input/output system comprises one or more objects.

15. The method of claim 12, wherein:
the proxy file comprises a plurality of sections for virtually all of the one or more devices;
a device file comprises one or more sections in the proxy file for each device of the one or more devices;
a section of the device file comprises a group/send table; and
the group/send table comprises public variable identifications.

16. A bus extension framework system comprising:
a heating, ventilation and air conditioning (HVAC) host controller;
a communications bus connected to the HVAC host controller; and
one or more device modules connected to the communications bus; and
wherein:
the HVAC host controller comprises:
a function block engine;
a storage mechanism connected to the function block engine; and
an input/output system connected to the function block engine;
the function engine comprises one or more function blocks;
the storage mechanism stores a proxy file incorporating configuration and/or communication information for virtually all of the one or more device modules.

17. The system of claim 16, wherein the one or more device modules comprise one or more sensors, displays, indicator devices, relays, wall modules, special processing units, and/or actuators.

18. The system of claim 17, wherein a sensor is a temperature sensor and/or a humidity sensor.

19. The system of claim 17, wherein a wall module comprises a thermostat and/or a processor.

20. The system of claim 17, wherein the proxy file comprises a group/send table for virtually all of the device modules.

21. The system of claim 17, wherein the proxy file further comprises under-the-hood detailed information about device modules, function blocks, components of input/output systems and connections between them.

22. The system of claim 21, wherein detailed information about device modules, function blocks, components of input/output systems and connections between them may be provided upon an on-the-fly up request while the system is operating.

23. The system of claim 16, wherein the communications bus is a multi-drop polarity-insensitive bus.
